(19) United States
(12) Patent Application Publication
(10) Pub. No.: US 2018/0222720 A1
(43) Pub. Date: Aug. 9, 2018

(54) ELEVATOR GUIDE SHOE ASSEMBLY

(71) Applicant: OTIS ELEVATOR COMPANY, Farmington, CT (US)

(72) Inventors: Fabrice Hamon, Les Choux (FR); Joachim Angoulevant, Saint Martin d'Abbat (FR); Arnaud Caze, Chailly en Gatinais (FR)

(21) Appl. No.: 15/745,238

(22) PCT Filed: Jul. 20, 2015
(86) PCT No.: PCT/IB2015/001875

§ 371 Date: Jan. 16, 2018

(51) Int. Cl. B66B 7/04; B66B 9/00; B66B 7/02; B66B 19/00

(52) U.S. Cl. CPC B66B 7/047; B66B 19/00; B66B 7/02; B66B 9/00

(57) ABSTRACT

An elevator guide rail assembly (22) includes a guide rail (28) extending along a centerline (30) and an elevator shoe arrangement (24) configured to axially slide along the guide rail (28). The elevator shoe arrangement (24) may include a bracket (32) having a first tab (36A, 36B) removably located in a slot (68) in the first shoe (34A, 34B). The tab (36A, 36B) and the first shoe (34A, 34B) may be configured such that the shoe (34A, 34B) may be removed from the tab (36A, 36B) without having to remove the guide rail (28) and/or dislocate the bracket (32).

### BACKGROUND

The present disclosure relates to an elevator system, and more particularly, to an elevator guide rail assembly.

Known elevator systems include a car propelled within a hoistway for carrying passengers and/or cargo between vertical levels or floors of a building. For rope elevators the elevator system also includes a rope arrangement extending between the car and a counterweight while be driven by a drive system that may include a motor and a rotating sheave that receives the rope. Typically, the counterweight weighs about the same as the car when loaded to about fifty percent capacity and is configured, via the rope, to rise when the car is lowered, and lower when the car is lifted between floors. In this way, the counterweight effectively reduces the work output of the drive system. Other elevator system types may include ropeless elevator systems that utilize a linear motor system to raise and lower the car. For ropeless elevator systems, a counterweight is not required.

Regardless of elevator system type, the car typically rides along at least one stationary guide rail that extends vertically within the hoistway. For rope elevator systems, the counterweight may also extend along at least one guide rail. A shoe arrangement engaged to the car and/or counterweight is in sliding contact with the guide rail and acts to steady the car and/or counterweight during travel along the guide rail and within the hoistway. Such shoe arrangements are known to be expensive to manufacture and/or difficult to maintain. Improvements in shoe arrangement design are desirable.

### SUMMARY

An elevator shoe arrangement is adapted for sliding contact with a guide rail extending along a centerline. The elevator shoe arrangement according to one, non-limiting, embodiment of the present disclosure includes a first shoe configured for sliding contact with the guide rail; and a bracket including a first tab disposed in a slot in the first shoe.

Additionally to the foregoing embodiment the first shoe is L-shaped.

In the alternative or additionally thereto, in the foregoing embodiment, the bracket is formed from a single sheet metal blank.

In the alternative or additionally thereto, in the foregoing embodiment, the first shoe includes a first portion substantially disposed normal to the first tab and a second portion defining the slot.

In the alternative or additionally thereto, in the foregoing embodiment, a fastening device carried by at least the second portion, and including a member removably disposed at least in-part in the second portion and projecting into the slot.

In the alternative or additionally thereto, in the foregoing embodiment, the second portion includes opposite first and second side walls each spanning between opposite first and second edges of the second portion, with the slot co-extending with and communicating through the first edge and the first side wall configured for sliding contact with the guide rail.

In the alternative or additionally thereto, in the foregoing embodiment, the second portion includes opposite first and second ends with the first and second side walls and the first and second edges spanning between the first and second ends, and wherein the slot communicates through the first end.

In the alternative or additionally thereto, in the foregoing embodiment, the first portion projects outward from the first side wall and is configured to be in sliding contact with the guide rail.

In the alternative or additionally thereto, in the foregoing embodiment, the arrangement includes a second shoe configured for sliding contact with the guide rail, and wherein a second tab of the bracket is disposed in a slot in the second shoe.

In the alternative or additionally thereto, in the foregoing embodiment, the first shoe is identical to the second shoe.

In the alternative or additionally thereto, in the foregoing embodiment, the first and second tabs are diametrically opposed and spaced radially outward with respect to the centerline.

In the alternative or additionally thereto, in the foregoing embodiment, the first tab is axially offset from the second tab with respect to the centerline.

An elevator system according to another, non-limiting, embodiment includes a guide rail extending along a centerline; and an elevator shoe arrangement configured to axially slide along the guide rail, the elevator shoe arrangement including a first shoe and a bracket including a first tab disposed in a slot in the first shoe.

Additionally to the foregoing embodiment, the elevator system includes a car, with the bracket is engaged to the car.

In the alternative or additionally thereto, in the foregoing embodiment, the elevator system includes a counterweight, with the bracket being engaged to the counterweight.

In the alternative or additionally thereto, in the foregoing embodiment, the elevator shoe arrangement includes a second shoe and the bracket includes a second tab disposed in a slot in the second shoe.

In the alternative or additionally thereto, in the foregoing embodiment, the first and second shoes include respective first and second side walls that oppose one-another with the guide rail in sliding contact there-between.

A method of dis-assembling an elevator shoe arrangement configured to slide along a guide rail extending along a centerline, according to another, non-limiting, embodiment includes removing a first fastening device engaged to at least a first shoe; sliding the first shoe in a first axial direction until the first tab is removed from an open ended slot in the first shoe; and moving the first shoe in a first radial direction until the first shoe clears the guide rail.

Additionally to the foregoing embodiment, the shoe includes a first and a second portion disposed normal to one another and the slot is in the second portion and the shoe is moved radially outward to clear the first portion from the guide rail.

In the alternative or additionally thereto, in the foregoing embodiment, the method includes removing a second fastening device engaged to at least a second shoe; sliding the second shoe in a second axial direction opposite the first axial direction and until the second tab is removed from an open ended slot in the second shoe; and moving the second shoe in a second radial direction opposite the first radial direction and until the second shoe clears the guide rail.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of an elevator system having a guide rail assembly of the present disclosure as one, non-limiting, exemplary embodiment;

FIG. 2 is an exploded perspective view of a shoe arrangement of the guide rail assembly;

FIG. 3 is a perspective view of the shoe arrangement;

FIG. 4 is a cross section of the guide rail assembly taken along line 4-4 of FIG. 3;

FIG. 5 is a perspective view of a second embodiment of the guide rail assembly;

FIG. 6 is a cross section of a third embodiment of a guide rail assembly similar in perspective to FIG. 4; and

FIG. 7 is a side view of a portion of the guide rail assembly in FIG. 6

### DETAILED DESCRIPTION

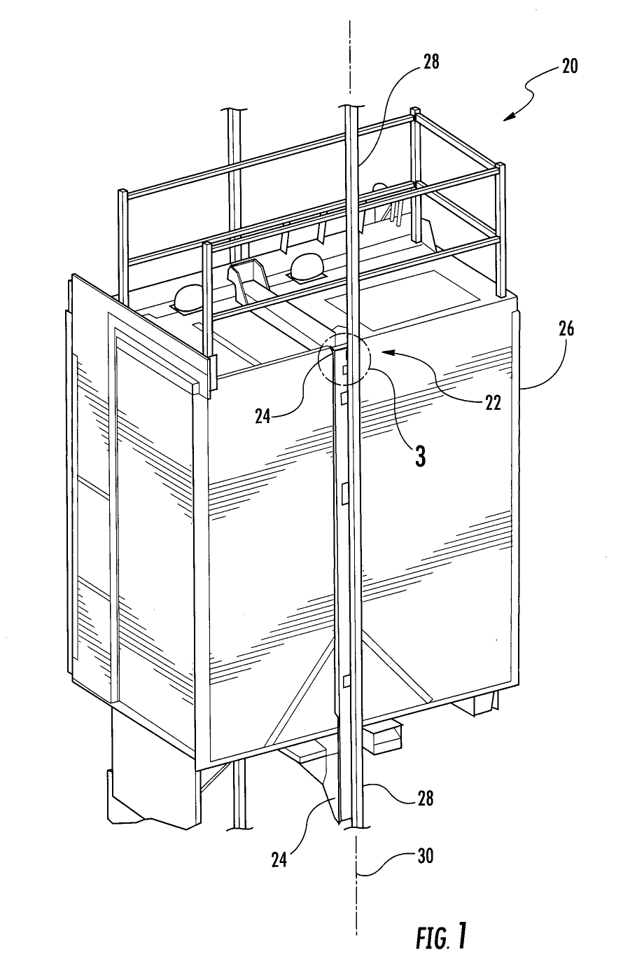

Referring to FIG. 1, an elevator system 20 that includes a guide rail assembly 22 of the present disclosure is illustrated. The guide rail assembly 22 may facilitate smooth travel of a car 26 of the elevator system 20 within a hoistway (not shown). The guide rail assembly 22 may include at least one shoe arrangement 24 (two illustrated) engaged to the car 26 and a stationary guide rail 28 that may extend substantially vertically within the hoistway along a centerline 30.

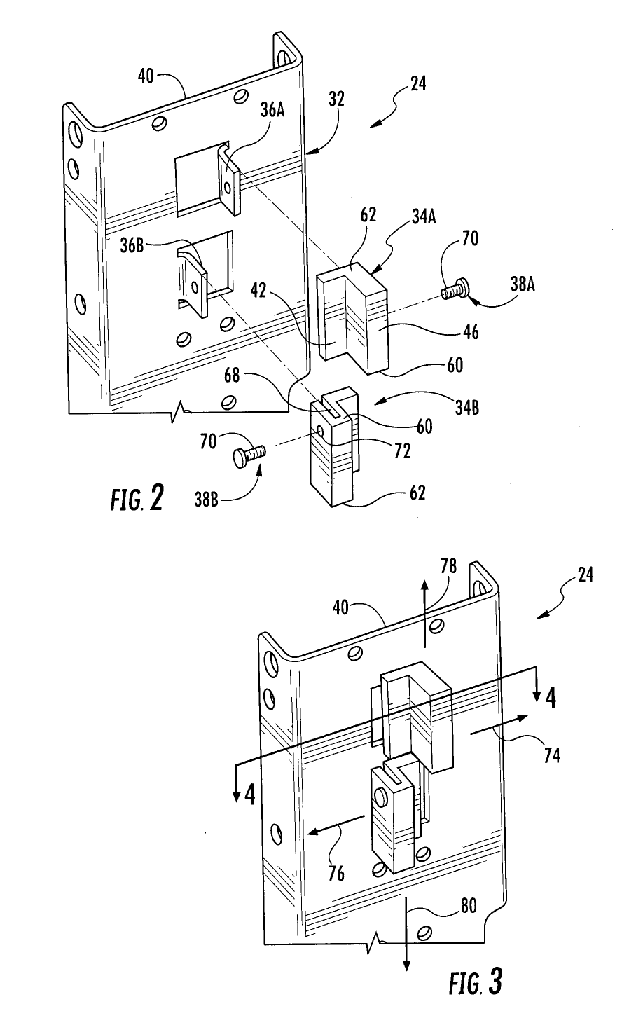

Referring to FIGS. 2 and 3, the shoe arrangement 24 may include a bracket 32, two shoes 34A, 34B that may be L-shaped and generally fit and slide over respective tabs 36A, 36B of the bracket 22, and respective fastening devices 38A, 38B. The bracket 32 travels with the car 26, and may further include a base 40 engaged to the car 26. The tabs 36A, 36B may be about normal to and project outward from the base 40. Each tab 36A, 36B may be substantially planar and parallel to one-another. When assembled and with respect to the centerline 30, the tabs 34A, 34B may be axially offset from one-another, and are radially spaced and diametrically opposed to one-another. For reduced cost, the bracket 32 may be manufactured from a single sheet, or blank, of steel with the tabs 36A, 36B stamped into a pre-determined shape and projection from the base 40.

Referring to FIGS. 2 through 4, the shoes 34A, 34B may each include a first portion 42 that may be in direct sliding contact with a front face 44 of the guide rail 28, and a second portion 46. The second portion 46 may include opposite first and second side walls 48, 50 with the first portion 42 projecting outward from and substantially normal to the first side wall 48. The front face 44 of the guide rail 28 spans between opposite first and second side faces 52, 54 with the first side face 52 being in sliding contact with the first side wall 48 of the second portion 46 of the first shoe 34A, and the second side face 54 being in sliding contact with the first side wall 48 of the second portion 46 of the second shoe 34B.

The second portion 46 of the shoes 34A, 34B may include opposite first and second edges 56, 58 each spanning substantially axially with respect to the centerline 30 when assembled, and with the first and second sidewalls 48, 50 of the second portion 46 each spanning between the first and second edges 56, 58 of the second portion 46. The second portion 46 may further include opposite first and second ends 60, 62 (see FIG. 2) facing in substantially opposite axial directions with respect to centerline 30 when assembled. The edges 56, 58 and the sidewalls 48, 50 may span substantially axially between the ends 60, 62 of the second portion 46.

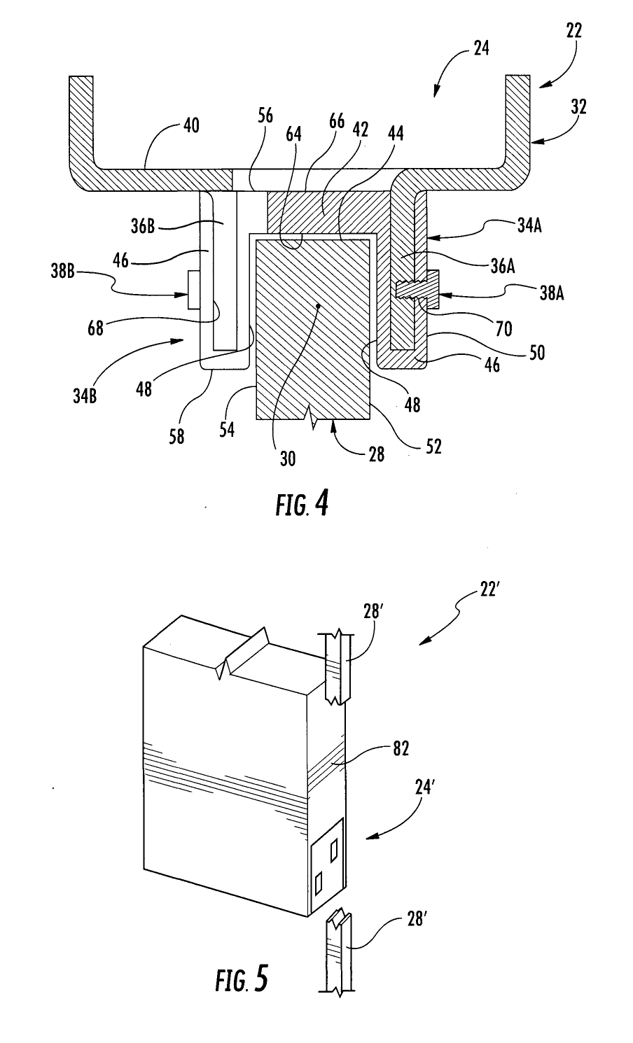

The first portion 42 may include opposite first and second surfaces 64, 66 (see FIG. 4) with the first surface 64 being in sliding contact with front face 44 of the guide rail 28 and the second surface 66 generally facing the base 40 of the bracket 32. The first edge 56 of the second portion 46 may form congruently with the second surface 66 of the first portion 42 (i.e., both lying along a common imaginary plane).

A slot 68 in the second portion 46 receives the respective tabs 36A, 36B, and includes boundaries defined by the second portion 46 of each shoe 34A, 34B. The slot 64 longitudinally communicates through the first edge 56 of the second portion 46 and through the first end 60 of the second portion 46. To assist in axial alignment of the shoes 34A, 34B with the respective tabs 36A, 36B during assembly, the slot 68 may not communicate through the second end 62 of the second portion 46.

The fastening devices 38A, 38B may each include a member 70 that removably extends through the second side wall 50 of the second portion 46 and into the respective tabs 36A, 36B. For example, the member 70 may be a threaded bolt that extends through a hole 72 (see FIG. 2) in the second side wall 50 and threads into the respective tabs 36A, 36B. The member 70 of each fastening device 38A, 38B may be removed in opposite radial directions with respect to the centerline 30 for ease of maintenance and/or access. It is further contemplated and understood that the fastening devices 38A, 38B may be any variety of fastening devices capable of securing the shoes 34A, 34B to the respective tabs 36A, 36B. Non-limiting examples of such fastening devices 34A, 34B may include screws, bolts, cotter pins, clipping mechanisms and others.

It is also contemplated and understood that fastening devices 34A, 34B may facilitate ease of placing and securing new shoes 34A, 34B over the tabs 36A, 36B. However, the fastening devices 34A, 34B may not facilitate intact removal of the old and/or worn shoes 34A, 34B. For example and not illustrated, the fastening devices 34A, 34B may be a clipping mechanism generally having a clip formed integral to the shoe as one piece. The clip may be configured to snap into or over a respective tab during assembly of a new shoe to the tab; however, prior removal of the old and/or worn shoe 34A, 34B from the tab may require plastic deformation of the clip to disengage the clip from the tab. The old or worn shoe may therefore be destroyed during the process of removal.

The shoes 34A, 34B may be identical in shape and/or material to reduce manufacturing costs and simplify maintenance activity. The guide rail 28 and the shoes 34A, 34B may be made of steel. Alternatively, and as one, non-limiting, example, the shoes 34A, 34B may be made of a softer material than the guide rail 28 such as, for example, brass or bronze, to reduce wear upon the guide rail 28. It is further contemplated and understood that the shoes 34A, 34B may be a composite or multi-layered with a base layer designed to add strength and an outer layer that may generally be in contact with the guide rail 28 designed to reduce friction, vibration, and/or noise there-between.

During disassembly of the shoe arrangement 24, and without first disassembling the guide rail assembly 22, the shoes 34A, 34B may be removed from the respective tabs 36A, 36B by first disengaging the respective fastening devices 38A, 38B. This may be accomplished, in one embodiment, by unthreading the member 70 of each device 38A, 38B and removing in opposite and radially outward directions (see arrows 74, 76 in FIG. 3) with respect to centerline 30. Once removed, the first shoe 34A may be slid axially in an upward direction (see arrow 78 in FIG. 3) until the second portion 46 of the first shoe 34A clears the tab 36A. Shoe 34A may then be moved in the radial direction 74 until the first portion 42 clears the guide rail 28. Similarly, the second shoe 34B may be slid axially in a downward direction (see arrow 80 in FIG. 3) until the second portion 46 of the second shoe 34B clears the tab 36B. Shoe 34B may then be moved in the radial direction 76 (i.e., opposite the radial direction 74) until the first portion 42 clears the guide rail 28.

Referring to FIG. 5, a second embodiment of a guide rail assembly is illustrated where like elements to the first embodiment have like identifying numerals except with the addition of a prime symbol suffix. The guide rail assembly 22′ includes a shoe arrangement 24′ and a guide rail 28′. The shoe arrangement 24′ is engaged directly to a counterweight 82 of the elevator system 20. The guide rail assembly 22′ functions to guide the counterweight 82 downward as a car 26 moves upward, and vice-versa.

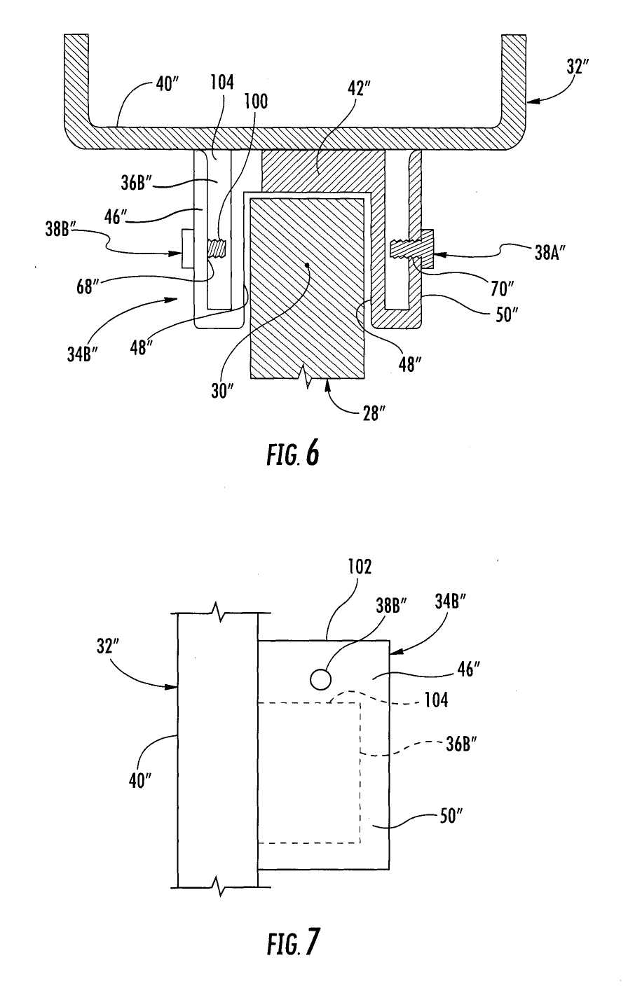

Referring to FIGS. 6 and 7, a third embodiment of a guide rail assembly is illustrated where like elements to the first embodiment have like identifying numerals except with the addition of a double prime symbol as a suffix. Fastening devices 38A″, 38B″ may each include a member 70″ that may extend through a hole 72″ in a side wall 50″ of the shoes 34A″, 34B″ and thread directly to the second side wall 50″. From the hole 72″, a distal portion 100 of the member 70″ may project into a slot 68″ of the shoes 34A″, 34B″; and, with respect to a centerline 30″, may be axially disposed between an open end 102 of the slot 68″ and an opposing edge 104 of the tabs 36A″, 36B″. In such a configuration, the distal portion 100 of the member 70″ may generally obstruct movement of the shoes 34A″, 34B″ with respect to the respective tabs 36A″, 36B″.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

1. An elevator shoe arrangement adapted for sliding contact with a guide rail extending along a centerline, the elevator shoe arrangement comprising:
a first shoe configured for sliding contact with the guide rail; and
a bracket including a first tab disposed in a slot in the first shoe.

2. The elevator shoe arrangement set forth in claim 1, wherein the first shoe is L-shaped.

3. The elevator shoe arrangement set forth in claim 1, wherein the bracket is formed from a single sheet metal blank.

4. The elevator shoe arrangement set forth in claim 1, wherein the first shoe includes a first portion substantially disposed normal to the first tab and a second portion defining the slot.

5. The elevator shoe arrangement set forth in claim 4 further comprising:
a fastening device carried by at least the second portion, and including a member removably disposed at least in-part in the second portion and projecting into the slot.

6. The elevator shoe arrangement set forth in claim 4, wherein the second portion includes opposite first and second side walls each spanning between opposite first and second edges of the second portion, with the slot co-extending with and communicating through the first edge and the first side wall configured for sliding contact with the guide rail.

7. The elevator shoe arrangement set forth in claim 6, wherein the second portion includes opposite first and second ends with the first and second side walls and the first and second edges spanning between the first and second ends, and wherein the slot communicates through the first end.

8. The elevator shoe arrangement set forth in claim 6, wherein the first portion projects outward from the first side wall and is configured to be in sliding contact with the guide rail.

9. The elevator shoe arrangement set forth in claim 1, further comprising:
a second shoe configured for sliding contact with the guide rail, and wherein a second tab of the bracket is disposed in a slot in the second shoe.

10. The elevator shoe arrangement set forth in claim 9, wherein the first shoe is identical to the second shoe.

11. The elevator shoe arrangement set forth in claim 9, wherein the first and second tabs are diametrically opposed and spaced radially outward with respect to the centerline.

12. The elevator shoe arrangement set forth in claim 9, wherein the first tab is axially offset from the second tab with respect to the centerline.

13. An elevator system comprising:
a guide rail extending along a centerline; and
an elevator shoe arrangement configured to axially slide along the guide rail, the elevator shoe arrangement including a first shoe and a bracket including a first tab disposed in a slot in the first shoe.

14. The elevator system set forth in claim 13 further comprising:
a car, and wherein the bracket is engaged to the car.

15. The elevator system set forth in claim 13, further comprising:
a counterweight, and wherein the bracket is engaged to the counterweight.

16. The elevator system set forth in claim 13, wherein the elevator shoe arrangement includes a second shoe and the bracket includes a second tab disposed in a slot in the second shoe.

17. The elevator system set forth in claim 16, wherein the first and second shoes include respective first and second side walls that oppose one-another with the guide rail in sliding contact there-between.

18. A method of dis-assembling an elevator shoe arrangement configured to slide along a guide rail extending along a centerline, the method comprising:
removing a first fastening device engaged to at least the first shoe;
sliding the first shoe in a first axial direction until the first tab is removed from an open ended slot in the first shoe; and
moving the first shoe in a first radial direction until the first shoe clears the guide rail.

19. The method set forth in claim 18, wherein the shoe includes a first and a second portion disposed normal to one another and the slot is in the second portion and the shoe is moved radially outward to clear the first portion from the guide rail.

20. The method set forth in claim 18, further comprising:
removing a second fastening device engaged to at least the second shoe;
sliding the second shoe in a second axial direction opposite the first axial direction and until the second tab is removed from an open ended slot in the second shoe; and
moving the second shoe in a second radial direction opposite the first radial direction and until the second shoe clears the guide rail.
